(19) United States
(12) Patent Application Publication
(10) Pub. No.: US 2003/0155726 A1
(43) Pub. Date: Aug. 21, 2003

(54) Gliding board arrangement

(76) Inventor: Dieter Braun, Sachsenkamm (DE)

Correspondence Address: DENNISON, SCHULTZ & DOUGHERTY, 1745 JEFFERSON DAVIS HIGHWAY, ARLINGTON, VA, 22202, US

(21) Appl. No.: 10/220,271

(22) PCT Filed: Mar. 8, 2001
(86) PCT No.: PCT/DE01/00884

(30) Foreign Application Priority Data
Mar. 8, 2000 (DE) 100 10 802.4
Mar. 8, 2000 (DE) 100 10 801.6

(51) Int. Cl. B62B 9/04

(52) U.S. Cl. 280/14.21; 280/607

(57) ABSTRACT

The invention concerns a gliding board design with innovative skiing features. The gliding board design consists of two gliding board halves (1, 2) on which shoe-fastening devices are mounted. Both gliding board halves (1, 2) are connected pivotally via a linkage construction whereby a bearing is attached to each shoe-fastening device. A pole each is fitted into the bearings in relation to the longitudinal extension of the gliding board design and is extended underneath the shoe-fastening device, whereby the two gliding board halves (1, 2) can be pivoted in relation to the pole. A coupling device connects the poles (5, 6), which can be rotated, whereby each pole is kept at such a distance from the surface of the gliding board halves (1, 2) and the coupling device has been constructed in such a way that it prevents contact with the gliding board halves (1, 2) due to deflection or tilting while skiing.

The invention concerns a gliding board configuration with innovative skiing features.

It is known from the state of the art how to improve or adapt the skiing features of a gliding board. It was suggested in DE 196 62 779, for example, to divide the gliding board lengthwise and to connect both parts with a special linkage construction, thereby creating innovative skiing characteristics. The linkage construction has the effect that the end segments of the two gliding boards are separated from each other at such a distance that the end segments can perform different upwards and downwards movements relative to each other. This feature is supposed to help improve adjustment to the ground.

A similar gliding board construction is already known from DE 43 24 871. U.S. Pat. No. 3,362,764 also describes a ski construction whereby two skis are connected by a flexible linkage construction.

There is permanent demand for ski sports equipment with improved or innovative skiing characteristics. It is therefore the goal of this invention to create a gliding board configuration that does justice to the various requirements of the users regarding the skiing features.

The objective of this invention is realized with a gliding board configuration according to claims 1, 12, 15, 17 and 19.

The gliding board configuration pursuant to claim 1 consists of two gliding board halves on which a shoe-fastening device has been installed on each half. Each shoe-fastening device is equipped with a bearing, whereby the bearing can also consist of several individual bearings. A pole is fitted in these bearings and can rotate within the bearing. The bearing is so configured that the poles are aligned parallel to the gliding board halves. It is especially important that the poles be at a sufficient distance from the surface of the gliding board halves. This distance is sufficient when a deflection of the gliding board halves occurs during the use of the gliding board, i.e., during skiing, and when the pole ends do not touch the surface of the gliding board halves. It is not possible to determine a concrete value for the distance, as this value depends on the constructive design, i.e., the elasticity of the gliding board halves. The concrete determination of the distance is therefore the task of the specialist who can perform this optimization without creative knowledge.

In addition, a coupling device is included connecting the poles with each other, whereby the linkage is not only possible at the end segments but also at other locations according to special applications. The coupling device bulges upwards in some application cases to make it possible that the coupling device does not touch the gliding board halves when these turn. These correlations are shown especially in the drawings so that the specialist can design the coupling device accordingly, without requiring any creative activity.

Pursuant to claim 2, the poles within the bearing can be longitudinally moved so that the poles form, together with the coupling device, a moveable framework that can be moved back and forward with the invented locked gliding board halves. In addition, a spring elastic centering device with springs working against each other is planned, keeping the poles at a predetermined centering position at a standstill—with locked in gliding boards according to the invention. During skiing, the resilient force of the spring elastic centering device can be overcome by leg strength in order to move the gliding board halves relative to each other.

Pursuant to claim 3, the spring elastic centering device is formed as a pressure spring device or as a pressure-tension spring device.

Pursuant to claim 4, the centering device consists of pressure springs or of pressure-tension springs, through which the poles extend. This design is especially simple and reliable.

Pursuant to claim 5, the pressure springs or the pressure-tension springs are placed in front of and behind the shoe-fastening device. This design is selected when a long shift distance for the gliding board halves is desired.

Pursuant to claim 6, the pressure springs or the pressure-tension springs are primarily placed under the shoe-fastening device. This design is selected when only a short shift distance is desired.

Pursuant to claim 7, the coupling device is built telescopically. A tension spring is installed at or in the coupling device, which pulls the gliding board halves together to a minimum distance limited by a stop. It is clear to the specialist that a stop also exists in the opposite direction to prevent the coupling device from being completely pulled apart.

The tension spring of the coupling device can be sized in such a way that the coupling device cannot be completely pulled apart when the gliding board design is used properly.

Pursuant to claim 8, the coupling device is also designed telescopically and is equipped with a tension-pressure spring configuration in order to keep the gliding board halves at a predetermined distance from each other when no outside forces are applied. Stops prevent an undesirable short or an undesirable long distance.

Pursuant to claim 9, a locking device is provided to keep the poles fastened in the bearings with regard to longitudinal flexibility so that the gliding board halves cannot move towards each other but can turn about their longitudinal axes. The locking device could consist, for example, of a simple clamping screw or a clamping jaw with an eccentric clamping lever. The longitudinal fastening of a movable rod in a sleeve using various methods is sufficiently known and therefore does not have to be explained in detail. It must be stressed that protection is claimed for this special design even if no detachable locking device is planned, but if the same effect is achieved by using appropriate constructive measures as in an un-detachable locking device.

This design opens the possibility of achieving skiing features similar to a snowboard. A wide variety of skiing features can be achieved by the discretionary adjustment of the gliding boards to each other.

Pursuant to claim 10, the bearings are designed in such a way that horizontal pivoting of the gliding board halves in relation to the poles is possible with a pivoting angle of 30° and that a vertical movement is prevented to a large degree.

In order to make such horizontal pivotal movement possible, the bearings must have horizontal clearance but vertical clearance must be prevented to a large degree. A specialist can build such bearings with basic knowledge of construction principles without using any creativity. An example of such bearings will be given in the description of a design example. A gliding board with the features pursuant to claim 10 makes it possible for the skier to move the gliding board halves independently of each other within a given range.

Pursuant to claim 11, adjustable stops are added on the bearing, with which the size of the pivoting angle can be adjusted leading to individual skiing features.

Pursuant to claim 12, an independent invention is claimed, which rests, however, on the same basic thoughts as the invention pursuant to claim 1 and which exhibits the essential characteristics of claim 1.

A gliding board design with two gliding board halves is presented, whereby a guide pole is fastened at each shoe-fastening device at the front side and at the backside that extends in the longitudinal direction of the gliding board half. A coupling device connects the poles that run through the pressure springs and can be rotated. The pressure springs are sustained on one side by the shoe-fastening device and at the other end by the coupling device.

It is characteristic of this invention that the platform of the shoe-fastening device is located lower than the centerline of the rods. The shoe-fastening devices and the shoe sole therefore lie lower than in the gliding board design pursuant to claim 1.

As in the invention pursuant to claim 1, the distance of each pole to the surface of each gliding board half is such and the coupling device is constructed in such a way that contact with the gliding board half due to deflection or tilting is impossible.

Pursuant to claim 13, the coupling device is designed telescopically and is equipped with a tension spring that pulls the gliding board halves together to a minimum distance that is determined by a stop. The skier can, if desired, press the gliding board halves apart by using the strength of his legs.

Pursuant to claim 14, a telescopic coupling device is again planned that is, however, equipped with a tension-pressure spring construction. With this feature, the gliding board halves are kept at a predetermined distance. The skier can press the gliding board halves together or apart, whenever he wishes.

Pursuant to claim 15, an independent invention is claimed, which rests, however, on the same basic thoughts as the invention pursuant to claim 1 and which also exhibits the essential characteristics of claim 1.

The gliding board design consists of two gliding boards with a shoe-fastening device mounted on each of them. On the backside of each shoe-fastening device of the front gliding board a first pole is attached, and a second pole is attached to the front side of the shoe-fastening device of the rear gliding board. At the end segments of the first and second poles, a first and second crossbeam are attached in the middle and rectangular to the poles. The end segments of the crossbeams are equipped with pivot bearings with two connection braces. The connection braces linking the crossbeams form a parallelogram construction.

Here, the rods and the linkage construction are designed in such a way that contact with either gliding board is excluded during skiing. The gliding board design has specific skiing features and conveys an innovative feeling when skiing.

Pursuant to claim 16, a spring elastic resetting device is attached to the parallelogram construction that presses the parallelogram construction into a rectangular form when it is unloaded, whereby the gliding board halves are arranged behind each other. Such a resetting design can be constructed using different methods that are sufficiently familiar to specialists. It is possible, for example, to use torsion rod springs in or at the pivot bearings.

Pursuant to claim 17, an independent invention is claimed, which rests, however, on the same basic thoughts as the invention pursuant to claim 1 and which exhibits the essential characteristics of claim 1.

The gliding board design consists of two gliding boards with one shoe-fastening device mounted on each. A first rod is attached at the rear of the shoe-fastening device of the front gliding board, and a second rod is attached at the front of the shoe-fastening device of the rear gliding board. The rods are connected to the pivotal parallelogram construction by two connection braces.

In this invention, the first connection brace is attached with an end section adjacent to the front shoe-fastening device at a rotary joint. The other end section of this connection brace is attached to the end of the second rod at a rotary joint. The second connection brace is attached with an end segment adjacent to the rear shoe-fastening device at a rotary joint, and the other end segment of this connection brace is attached to the end of the first rod at a rotary joint.

The rods and the linkage construction are designed in such a way that contact with either gliding board is excluded when skiing. The gliding board construction has specific skiing features and conveys an innovative feeling when skiing.

Pursuant to claim 18, a spring elastic resetting device is so designed that it retains the unloaded gliding board in such a position that the second gliding board is located directly behind the first gliding board in a straight line. The above description pursuant to claim 16 is valid for the design of the spring elastic resetting device.

Pursuant to claim 19, an independent invention is claimed, which rests, however, on the same basic thoughts as the invention pursuant to claim 1 and which exhibits the essential characteristics of claim 1.

The gliding board design consists of two gliding boards with one shoe-fastening device mounted on each. Both gliding board halves are flexibly connected to each other with linkage construction. Below each shoe-fastening device, a rod extends longitudinally to the gliding board halves. A coupling device connects the rods with each other pivotally, whereby each rod is positioned at a sufficient distance from the surface of each gliding board half, and the coupling device is constructed in such a way that contact with the gliding board halves is excluded when the gliding boards flex or tilt during skiing. The coupling device has the following features in a stationary position:

A limit stop is attached at each rod segment. A mid-stop is planned at the middle segment of each rod at the front and the rear of the shoe-fastening device. Between the limit stop and the mid-stop, two sliding and pivotal floating bushings are allocated to each floating bushing pair on the rods. Four pressure springs are attached to the rods whereby each pressure spring has been installed between two floating bushings of a floating bushing pair. Due to the resilient force, one of the floating bushing pairs is pressed against the limit stop and the other floating bushing pair is pressed against the middle stop. Therefore, a front floating bushing pair and a rear floating bushing pair exist on each rod. The front four floating bushings are connected crosswise with one another via two front pushrods. The connecting points are designed as rotary joints. The rear four floating bushings are connected crosswise with one another via two rear pushrods. The connecting points are also designed as rotary joints.

Pursuant to claim 20, the stops on the rods are adjustable and can be locked, i.e., the stops can be slid along the rod and can be fastened at a selected location; this means that skiing features can be varied.

Pursuant to claim 21, the springs are exchangeable, meaning that the skiing features can be varied.

Pursuant to claim 22, springs are installed before the front floating bushings and behind the rear floating bushings so that each floating bushing is kept in a central position. This position results from the equilibrium of the resilient forces acting upon one another. The springs need not be identical. The use of springs with different strengths or lengths results in many variations, causing a very individual skiing effect.

Pursuant to claim 23, springs are attached before the front floating bushings or behind the rear floating bushings. This measure also serves to adjust individual skiing techniques.

Pursuant to claim 24, the gliding board halves have an interior radius at their lateral edge that improves the skiing features of the gliding board design.

Pursuant to claim 25, the gliding board design is such that the gliding board halves are designed asymmetrically. With this gliding board design, the offset of the gliding board halves to each other has been determined. This gliding board design is thus skied like a snowboard, whereby each gliding board half can be rotated about its longitudinal axis. As shown in Fig. . . . , the forms of the gliding board halves, their offset to each other, and the side radius, have been designed in such a way that the left side radius of the left gliding board half with the left side radius of the right gliding board half has the same circular arc as the right side radius of the right gliding board half with the right slide radius of the left gliding board, whereby the respective circular arcs are offset parallel to each other. This design facilitates excellent skiing in curves.

Pursuant to claim 26, the radii are designed in such a way that the platform edges ski around a common center when skiing curves. This design facilitates skiing curves to an even greater degree.

The invention is described in greater detail below with the help of some examples:

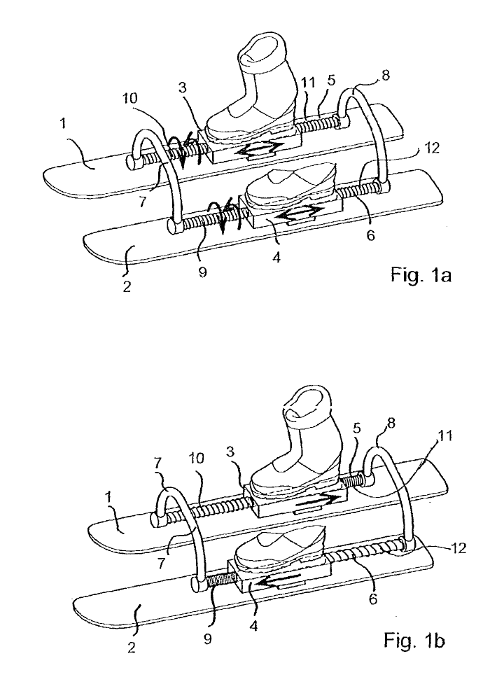

FIG. 1 Shows the invention in the first design.

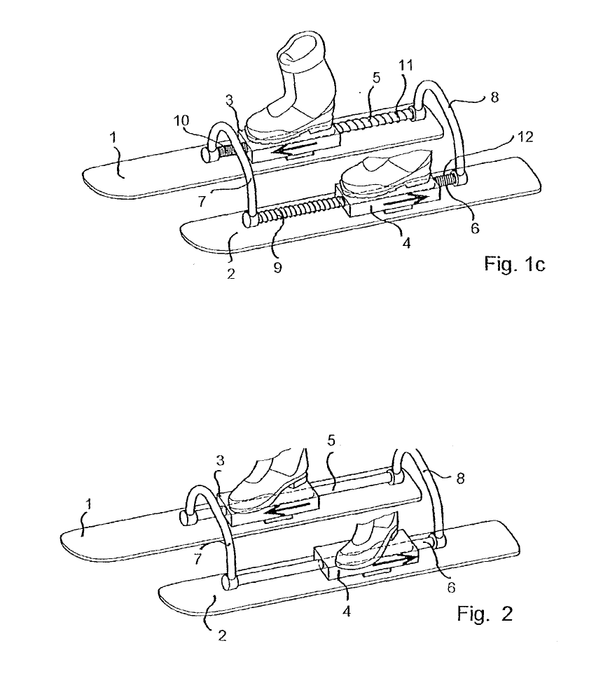

FIG. 2 Shows the invention in the second design.

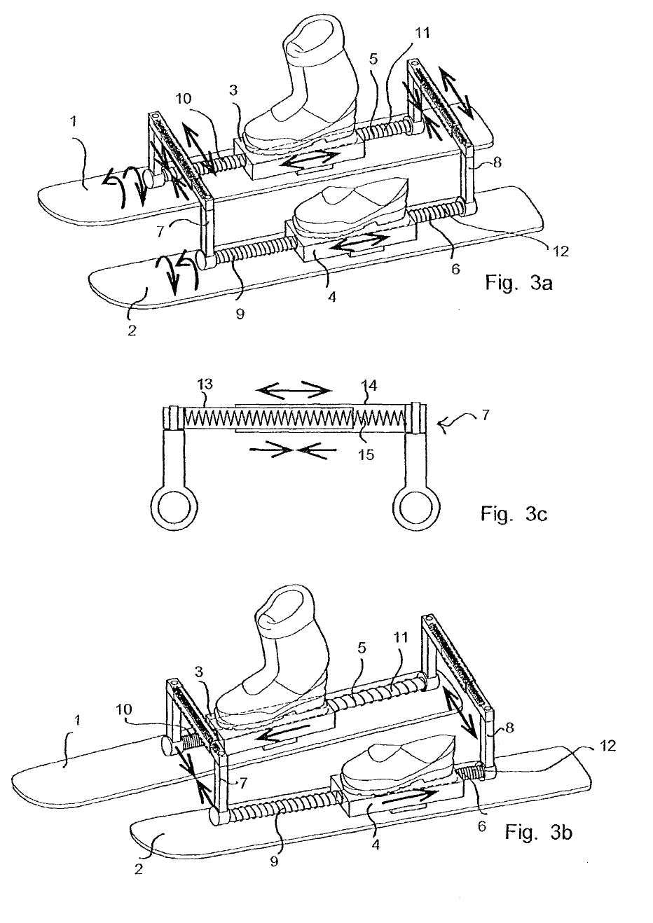

FIG. 3 Shows the invention in the third design.

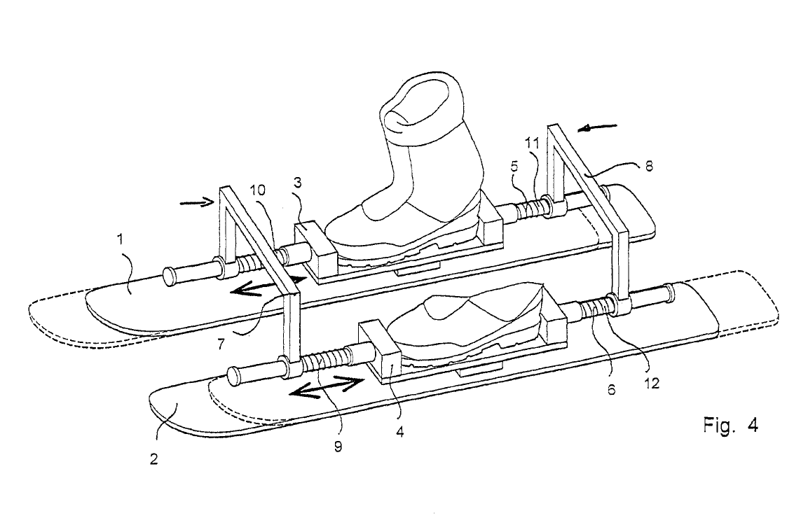

FIG. 4 Shows the invention in the fourth design.

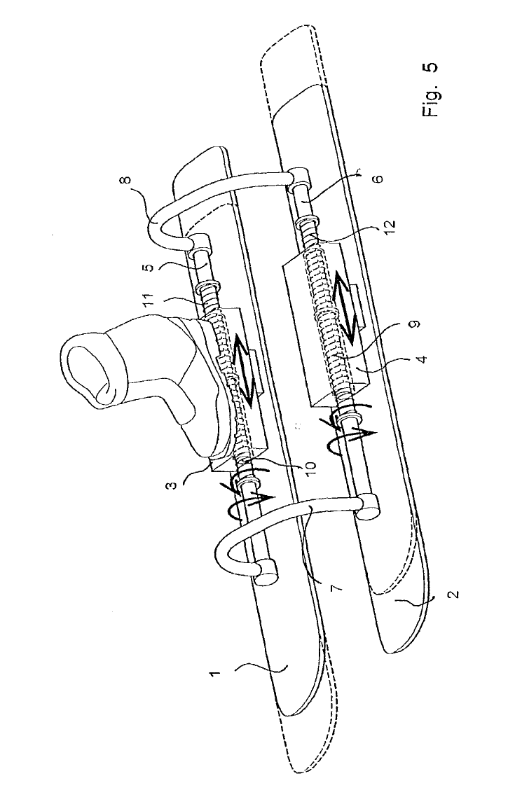

FIG. 5 Shows the invention in the fifth design.

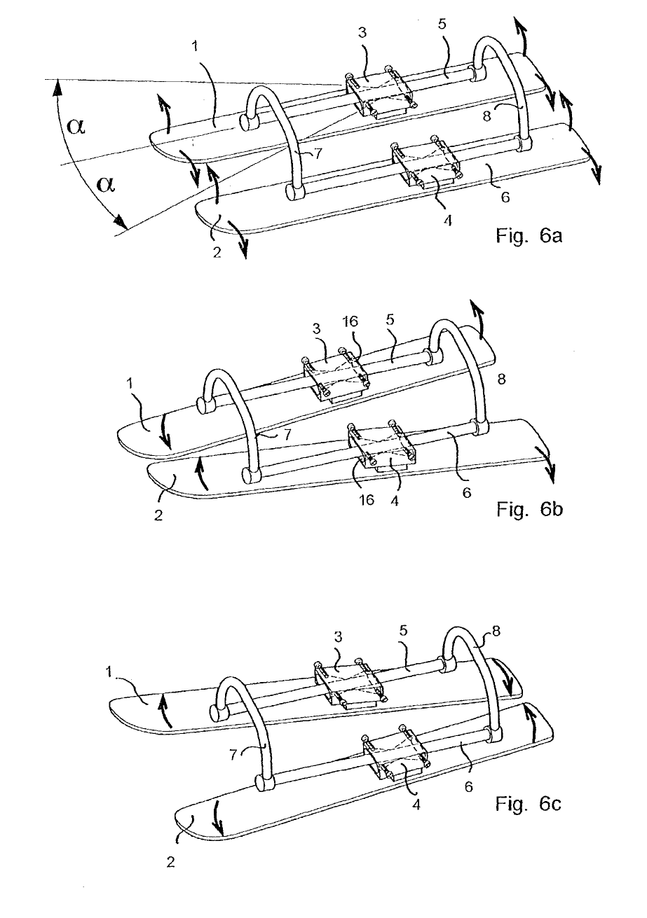

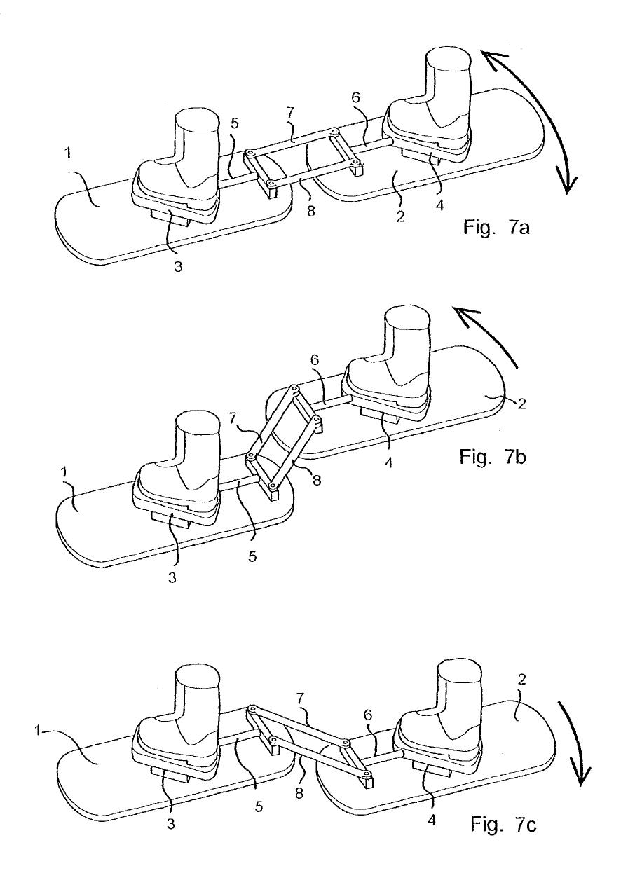

FIG. 6 Shows the invention in the sixth design.

FIG. 7 Shows the invention in the seventh design.

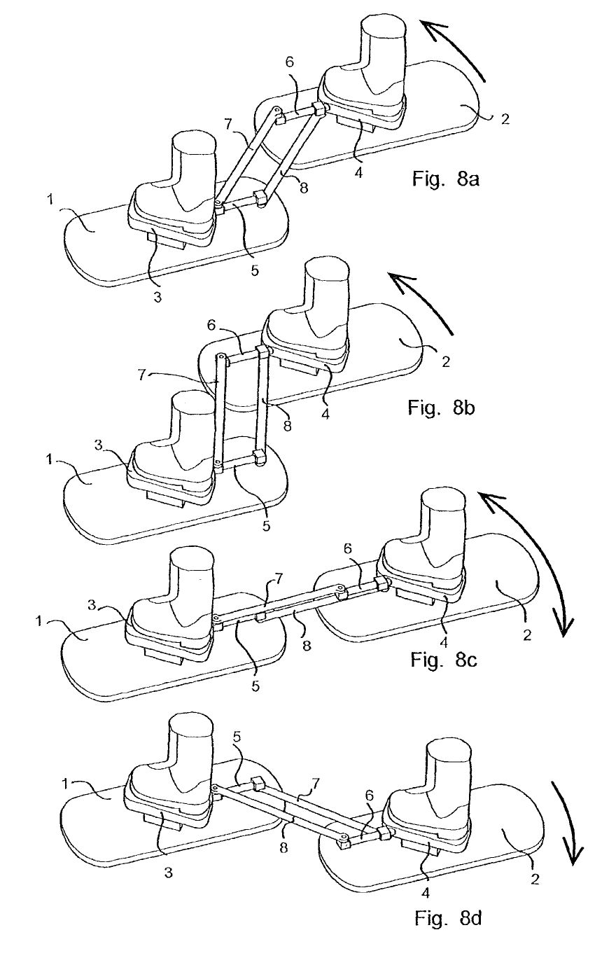

FIG. 8 Shows the invention in the eighth design.

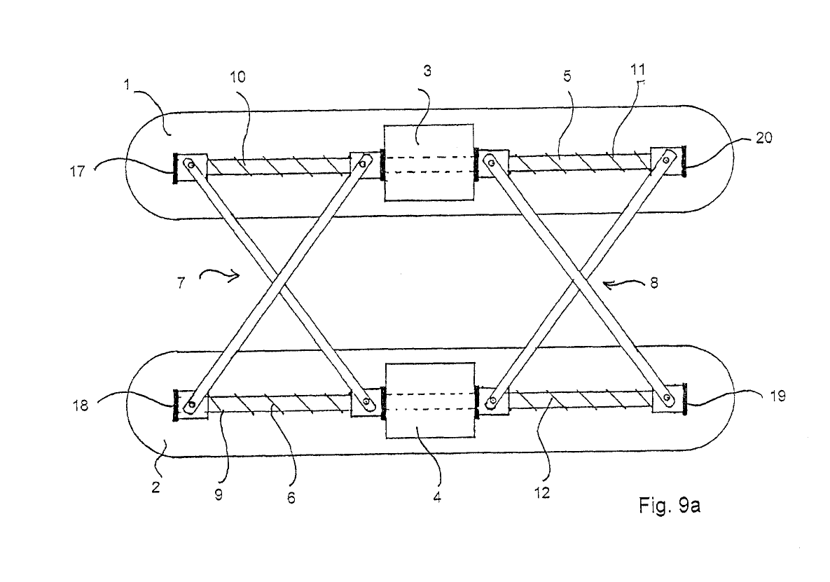

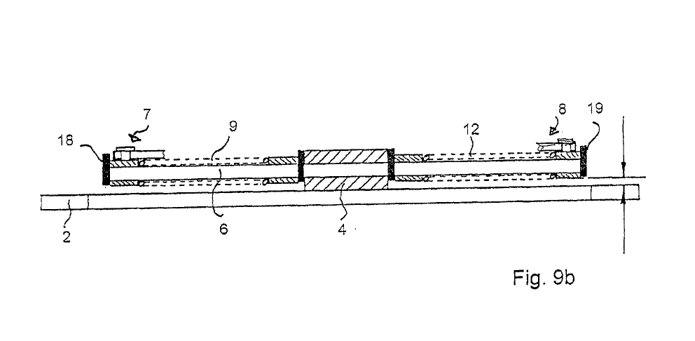

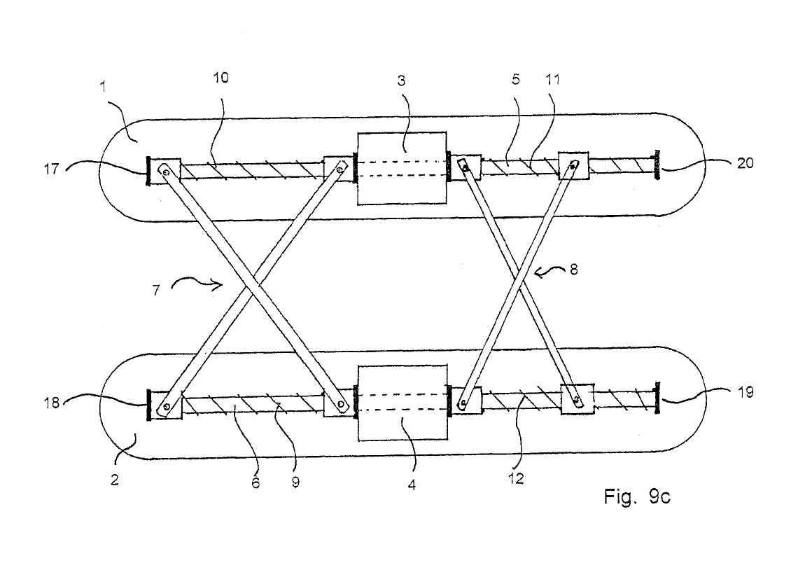

FIG. 9 Shows the invention in the ninth design.

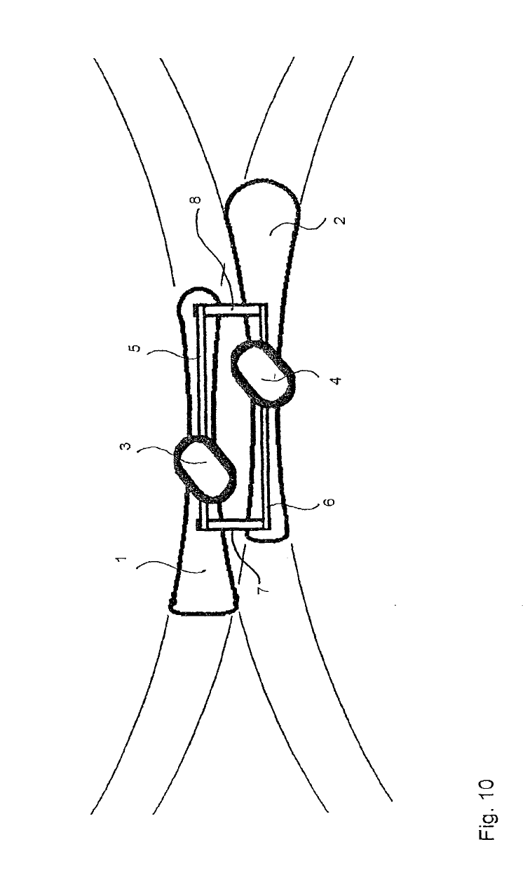

FIG. 10 Shows the invention in the tenth design.

FIG. 1 shows: a gliding board design with two gliding board halves 1, 2. A bearing block is mounted on each gliding board half through which a rod 5, 6 is extended. The shoe-fastening device is mounted on the bearing block. The rods can easily be fitted into the bearing. Even if a person stands on the gliding board halves 1, 2, the rods can be moved easily. The bottom side of the rod 5, 6 has a distance to the surface of the gliding board of approximately 30 mm in the present example. The rod ends are connected and can rotate via a coupling device that is bent upwards. The gliding board halves 1, 2 can, therefore, be turned in either direction of the curved arrows. The rods are slid through coil springs. In the present example, the coil springs are designed as tension- and pressure springs, which are attached at their ends. This spring design forms a spring elastic centering device, which keeps the rods in a predetermined position by its resilient force. It is assumed for the purpose of explaining the function, that all four springs are of equal length and the same flexibility and that they are slightly pre-stressed; i.e., they are sustained at the front and back by the coupling device and in the middle by the toe and the heel ends of the shoe-fastening device. This neutral position is shown in FIG. 1a.

If a person stands on the gliding board and the gliding board lies on the snow-covered ground, the person can shift the two gliding board halves 1, 2 toward each other in a predetermined way through the strength of his legs whereby the resetting forces of the four springs must be overcome. If the springs are attached at both ends, the crossover springs are compressed or pulled when the gliding board halves 1, 2 are moved toward each other. In FIGS. 1b and 1c, the shifted positions are shown whereby the arrows show the direction of the tensions.

If a person skies a straight line with the sliding board, the sliding board halves 1, 2 are in the position shown in FIG. 1a, and if he skies a curve, the gliding board halves 1, 2 are offset according to FIGS. 1b and 1c, indicating a curve.

FIG. 2 shows a second design of the invention. In contrast to the embodiment pursuant to FIG. 1, in the second design the gliding board halves 1, 2 are not at a standstill next to each other, but offset toward each other. If necessary, the shoe-fastening devices can be pivoted slightly so that the skier assumes a skiing position that is similar to the skiing position of a traditional snowboard. In this design, the lock of the poles (not shown), which does not permit a shift in the longitudinal direction after the lock, must be taken into consideration. Such a lock can be accomplished e.g. by using a clamping screw. In this case, the poles in the coupling device must be capable of turning.

FIG. 3 shows a third design of the invention. The design corresponds to a large extent to the first design. The coupling device is, however, built telescopically. In the present example, the horizontal segment of the coupling device is constructed from two pipes that are inserted, one into the other, where a pressure-tension spring is attached. This pressure-tension spring is attached at the ends within the pipe so that it can have the effect of a tension spring as well. FIG. 3b shows the construction of the coupling device in detail.

The horizontal segment is fastened via pivotal joints to the vertical poles. FIG. 3a shows the gliding board in a neutral position. The arrows show the movement options. FIG. 3c shows that the front coupling device is pressed together through the force input of the skier and that the rear coupling device is pulled apart to facilitate skiing curves. It is clear to the specialist that the spring in the embodiment shown must be sized in such a way that a complete pulling-apart of the pipes is safely avoided. This circumstance can also be avoided by using a stop.

FIG. 4 shows a gliding board design with two gliding board halves 1, 2, whereby a guide rod is attached at each shoe-fastening device at the front and rear, with said rod extending in the longitudinal direction of the gliding board halves. The rods, which can be rotated, are attached to each other with a coupling device. In addition, pressure springs are attached to the rods, which are sustained at one end at the shoe-fastening device and at the other end at the coupling device. Tension F and its external effect on the coupling device are shown in FIG. 4, with the result that the coupling device is always shifted in the direction of the shoe-fastening device. This presentation was selected to clarify the function of this gliding board design.

It is a characteristic of this gliding board design that the platform level of the shoe-fastening device lies underneath the rods. The platform surface of the shoe-fastening devices and the shoe sole therefore lie deeper than those in previously described designs.

FIG. 5 shows a design where most of the springs are attached beneath the shoe-fastening device. This design is selected when only a small sliding path is required. It is obvious from the drawing that two springs are attached to each rod 5, 6, which are sustained by an outer stop and a joint inner stop in the bearing block.

FIG. 6a shows a design of a bearing block where the horizontal movement of the gliding board halves 1, 2 in relation to the rods makes a pivotal α angle of approximately 30° possible. For this purpose, the bearing must be extended toward the front and the back, as can be seen in the drawing. This extension is planned, however, in the horizontal plane so that a vertical movement of the gliding boards is prevented to a large degree. Using this gliding board, the skier can move the gliding board halves 1, 2 independently of each other within a given range without much exertion, as shown in FIGS. 6b and 6c. In the present design, additionally adjusting screws are planned in order to limit the pivotal α angle.

FIG. 7 shows a gliding board design with two gliding board halves 1, 2 that are connected with each other on a sliding basis via a coupling construction. A first pole is attached on the back side of the shoe-fastening device of the front gliding board, and a second pole is attached at the front side of the shoe-fastening device of the rear gliding board. At the end segments of the first and second poles 5, 6 a first and second crossbeam is attached at the center and rectangular to the poles. Connection braces are attached at the end segments of the crossbeams at the fulcrums, connecting the crossbeams in such a way that a pivotal parallelogram design is formed. FIG. 7a shows a position where the gliding board halves 1, 2 are positioned in sequence and where the parallelogram construction forms a rectangle. FIGS. 7b and 7c show a panning of the rear gliding board to the right side and left side, whereby the function of the parallelogram construction can be clearly seen in the drawing and does not require further explanation.

FIG. 8 shows another gliding board design with two gliding board halves 1, 2 that are also connected via a parallelogram construction. The design of this parallelogram construction is similar to that described earlier. The kinematic conditions are similar so that the expert can deduce the technical theory by looking at FIGS. 8a-8d.

The spring resetting elements can be provided in the joints for the design pursuant to FIG. 7 and the design pursuant to FIG. 8 in order to press the gliding board halves 1, 2 into a pre-determined position.

FIGS. 9a, b show another gliding board design with two gliding board halves 1, 2, which are also connected via a linkage construction. Each shoe-fastening device has a bearing. One pole each is fitted into a bearing relative to the longitudinal extension of gliding board halves 1, 2 and runs underneath the shoe-fastening device, whereby the two gliding board halves 1, 2 can be turned relative to the pole 5, 6. A coupling device connects the poles, which can be turned, whereby each pole 5, 6 has such a distance from the surface of the respective gliding board half and the coupling construction is designed such that contact with the gliding board halves 1, 2 due to deflection or tilting can be avoided while skiing. The coupling device has the following features in a stationary position:

A final stop is attached at each pole segment. A stop is planned in the middle segment of each pole 5, 6 at the front and back sides of the shoe-fastening device. Two sliding and rotating floating bushings are fastened on the poles between one final stop and a stop at the shoe-fastening device. Four pressure springs are slid over the poles, whereby each pressure spring is positioned between two floating bushings. Each pressure spring pushes two floating bushings against two opposite stops. In the viewing direction, the left front floating bushing is connected via a first pushrod with the right floating bushing next to the middle stop via a rotary joint. Accordingly, the right front floating bushing is connected via a second front pushrod with the left floating bushing that lies next to the middle stop by way of a rotary joint, forming a cross of the front pushrods. Analog to this design, the rear floating bushes are connected cross-wise with rear pushrods. These advantageous features can be seen in the top view of FIG. 9a. FIG. 9b shows the side view, where it can be seen that the poles and the connection construction show a distance α from the gliding board surface.

It should be stressed that the pushrods are not connected at their intersecting point. This gliding board design conveys a specific ski feeling and good curve performance.

FIG. 9c shows a modified further development of the design shown in FIGS. 9a and b. In this design, a spring is installed before each front floating bushing so that the floating bushing assumes a predetermined position that depends on the spring tension. This gliding board design also conveys a specific skiing feeling and has excellent curve performance.

FIG. 10 shows a gliding board design where the gliding board halves 1, 2 are formed asymmetrically. With this gliding board design an offset of the gliding board halves 1, 2 in relation to each other is predetermined. The gliding board design is therefore skied like a snowboard, whereby the gliding board halves 1, 2 can be rotated about their longitudinal axis. As can be seen, the form of the gliding board halves 1, 2, the offset and the side radii are selected in such a way that the left side radius of the left gliding board half is identical to the left side radius of the right gliding board half for left curves; that means that both circular arcs have the same radius and they are offset in a parallel fashion. The analogue design is valid for a right curve.

In conclusion, it should be again mentioned that each of the described designs contain poles and coupling devices whereby each pole has a sufficient distance from the surface of the gliding board half and whereby the coupling device is designed such that it excludes contact with the gliding board halves 1, 2 due to deflection or tilting while skiing.

1. Gliding board design with two gliding board halves (1, 2) on which a shoe-fastening device is mounted and where both gliding board halves (1, 2) are connected with each other in a movable fashion through a linkage construction characterized by the following features:
a bearing is attached to each shoe-fastening device,
a pole is fitted into the bearings in relation to the longitudinal extension of the gliding board and runs underneath the shoe-fastening device, whereby
the two gliding board halves (1, 2) can be rotated in relation to the pole
a coupling device (7, 8) connects the poles (5, 6) which can be rotated, whereby
each pole (5, 6) has such distance from the surface of the gliding board half and the coupling device (7, 8) is designed such that contact with the gliding board halves (1, 2) is excluded due to deflection or tilting during skiing.

2. Gliding board pursuant to claim 1, characterized in that the poles (5, 6) are fitted into the bearing and can be slid longitudinally and that a spring elastic centering device with springs (9, 10, 11, 12) working against one another hold the poles (5, 6) in a predetermined centering position so that the gliding board halves (1, 2) can be moved relative to each other after the spring tension of the gliding board halves (1, 2) has been overcome.

3. Gliding board pursuant to claim 2, characterized in that the spring elastic centering position is formed as a pressure spring design, or as a pressure-tension spring design.

4. Gliding board pursuant to claim 3, characterized in that the centering device is formed of pressure springs (9, 10, 11, 12) or through pressure-tension springs through which the poles (5, 6) extend.

5. Gliding board pursuant to claim 4, characterized in that the pressure springs (9, 10, 11, 12) or the pressure-tension springs are attached before or behind the shoe-fastening device.

6. Gliding board pursuant to claim 4, characterized in that the pressure springs (9, 10, 11, 12) or the pressure-tension springs are predominantly arranged underneath the shoe-fastening device.

7. Gliding board pursuant to claim 2 or 3, characterized in that the coupling device (7, 8) is designed telescopically and is equipped with a tension spring that pulls the gliding board halves (1, 2) towards a minimum distance limited by a stop.

8. Gliding board pursuant to claim 2 or 3, characterized in that the coupling device (7, 8) is designed telescopically and is equipped with a pressure-tension spring construction holding the gliding board halves (1, 2) at a predetermined distance in relation to each other, whereby the distance can be predetermined by the size of the tension and pressure.

9. Gliding board pursuant to one of the claims 1 to 8, characterized in that a locking device is planned to lock the poles (5, 6) in the bearings so that the gliding board halves (1, 2) cannot be moved toward each other but continue to rotate about their axis in the longitudinal extension.

10. Gliding board pursuant to one of the claims 1 to 9, characterized in that the bearings are formed in such a way that a horizontal pivoting of the poles (5, 6) with a pivot angle of 30° is possible and that a vertical motion is prevented to a large extent.

11. Gliding board pursuant to claim 10, characterized in that the pivot angle can be limited with adjustable stops.

12. Gliding board design with two gliding board halves (1, 2) where a shoe-fastening device is mounted on each of them and where both gliding board halves (1, 2) are connected via a linkage construction, whereby they can be rotated, characterized by the following features:
a guide rod is attached to each shoe-fastening device at the front and rear, extending in the longitudinal direction of the gliding board half,
a coupling device (7, 8) connects the poles (5, 6) which can be rotated,
the poles (5, 6) run through the pressure springs (9, 10, 11, 12) which are sustained at the coupling device (7, 8) and at the shoe-fastening device, whereby
the front coupling devices are pressed forward against a front push rod stop and the back coupling devices are pressed backwards against the back push rod stop, and
the platform level of the shoe-fastening device lies underneath the center line of the poles (5, 6), whereby
each pole has such a distance from the surface of the gliding board half and the coupling device (7, 8) is designed in such a way that contact with the gliding board halves (1, 2) due to deflection or tilting when skiing is excluded.

13. Gliding board pursuant to claim 12, characterized in that the coupling device (7, 8) is designed telescopically and is equipped with a tension spring that pulls the gliding board halves (1, 2) together to a minimum distance determined by a stop.

14. Gliding board pursuant to claim 12, characterized in that the coupling device (7, 8) is designed telescopically and is equipped with a pressure-tension spring construction that keeps the gliding board halves (1, 2) at a predetermined distance, whereby the distance is predetermined by the amount of pressure and tension.

15. Gliding board design with two gliding boards, where a shoe-fastening device is mounted on each of them and where both gliding boards are connected with each other via a linkage construction and whereby both can be rotated, characterized by the following features:
a first pole is attached at the backside of the shoe-fastening device of front gliding board,
a second pole is attached to the front side of the shoe-fastening device of the rear gliding board,
a first and second crossbeam are attached at the center and rectangular to the poles (5, 6) at the final segments of the first and second poles and
connection braces are designed at the pivots in the final segments of the crossbeams, connecting the crossbeams in such a way that a pivotal parallelogram construction is formed, whereby
each pole and the crossbeams have a distance from the respective gliding board and the parallelogram construction is such that contact with the gliding board halves (1, 2) is excluded due to deflection or tilting during skiing.

16. Gliding board design pursuant to claim 15, characterized in that a spring elastic resetting device is planned, which presses the parallelogram construction into a rectangle when unloaded whereby the gliding boards are designed in sequential order.

17. Gliding board design with two gliding boards on which a shoe-fastening device is mounted on each and whereby both gliding boards are connected to each other via a linkage construction and whereby both can be rotated, characterized by the following features:
a first pole is attached to the backside of the shoe-fastening device of the front gliding board,
a second pole is attached to the front side of shoe-fastening device of the rear gliding board,
two connection braces connect the poles (5, 6) to a pivotal parallelogram construction, whereby
a first connection brace is attached to the final segment close to the front shoe-fastening device at a pivot and the other end segment is fastened at the end of the second pole to a pivot, and
a second connection brace is fastened with an end segment close to the back shoe-fastening device at a pivot and the other end segment is fastened at the end of the first pole at a pivot.

18. Gliding board design pursuant to claim 17, characterized in that a spring-elastic resetting device is planned that puts the gliding boards in such a position when unloaded that the second gliding board is positioned in a straight line behind the first gliding board.

19. Gliding board design with two gliding board halves (1, 2) where shoe-fastening devices are mounted on each and where the two gliding board halves (1, 2) are connected via a linkage construction and whereby both can be rotated, characterized by the following features:
a bearing is attached to each shoe-fastening device
a pole is fitted into the bearing in a longitudinal direction of the gliding board halves (1, 2) and extends underneath the shoe-fastening device, whereby the two gliding board halves (1, 2) can be rotated vis-à-vis the pole
a coupling device (7, 8) connects the poles (5, 6) which can be rotated, whereby each pole has a distance from the surface of the respective gliding board half and the coupling device (7, 8) is designed in such a way that contact is excluded with the gliding board halves (1, 2) due to deflection or tilting during skiing, and that the coupling device (7, 8) has the following features in a stationary position:
a final stop (17, 18, 19, 20) is attached at each pole end segment,
a stop is planned in the mid-segment of each pole at the front side and back side of the shoe-fastening device,
two moveable and rotating floating bushings are attached to the poles (5, 6) between the final stop (17, 18, 19, 20) and a stop at the shoe-fastening device,
four pressure springs (9, 10, 11, 12) are attached to the poles (5, 6), whereby each pressure spring is mounted between two floating bushings that are pressed against the stops with spring tension,
the left front floating bushing is connected pivotally via a first front push rod to the right floating bushing located at the middle stop via a pivot,
the right front floating bushing is connected pivotally via a second front push rod to the left floating bushing located at the middle stop via a pivot,
the left back floating bushing is pivotally connected via a first back push rod to the right floating bushing located at the middle stop via a pivot,
the right back floating bushing is connected pivotally via a second back push rod to the left floating bushing located at the middle stop via a pivot.

20. Gliding board design pursuant to claim 19, characterized in that the stops on the poles (5, 6) are adjustable and can be locked.

21. Gliding board design pursuant to claim 19 or 20, characterized in that the springs (9, 10, 11, 12) can be exchanged.

22. Gliding board design pursuant to one of the claims 19 to 21, characterized in that springs are attached before the front floating bushings and behind the back floating bushings.

23. Gliding board design pursuant to one of the claims 19 to 21, characterized in that springs are attached before the front floating bushings or behind the back floating bushings.

24. Gliding board design pursuant to one of the previous claims, characterized in that the gliding board halves (1, 2) have an interior radius at the lateral edge.

25. Gliding board design pursuant to claims 9 and 24, characterized in that the gliding board halves (1, 2) are asymmetrical, whereby the offset of the gliding board halves (1, 2) and the side radii are selected in such a way that
the left side radius of the left gliding board half with the left side radius of the right gliding board half has the same circular arc as the right side radius of the right gliding board half with the right side radius of the left gliding board half. (FIG. 10)

26. Gliding board design pursuant to claims 9 and 24, characterized in that the gliding board halves (1, 2) are formed asymmetrically, whereby the offset of the gliding board halves (1, 2) to each other and the side radii are selected in such a way that the surface edges ski around the same center in curves.
